(19) United States
(12) Patent Application Publication
(10) Pub. No.: US 2009/0234866 A1
(43) Pub. Date: Sep. 17, 2009

(54) Floating Point Unit and Cryptographic Unit Having a Shared Multiplier Tree

(76) Inventors: Paul Caprioli, Santa Clara, CA (US); Leonard D. Rarick, San Jose, CA (US)

Correspondence Address: MHKKG/SUN, P.O. BOX 398, AUSTIN, TX, 78767, US

(21) Appl. No.: 12/049,673

(22) Filed: Mar. 17, 2008

(51) Int. Cl. G06F 17/30

(52) U.S. Cl. 707/100; 707/E17.009

(57) ABSTRACT

Sharing a multiplier tree between a floating point unit and a cryptographic unit in a system. The system may include a processor core configured to perform general processing operations, a floating point unit configured to perform floating point operations, a cryptographic unit configured to perform cryptographic operations, and a multiplier tree for performing multiply operations for the units. The multiplier tree may include a feedback path and memory elements in the feed back path. The feedback path and memory elements may be used when the multiplier tree is performing multiply operations for the cryptographic unit and may not be used when performing operations for the floating point unit.

### FIELD OF THE INVENTION

The present invention relates to the field of processing units, and more particularly to a system and method for sharing a multiplier tree between a floating point unit and a cryptographic unit.

### DESCRIPTION OF THE RELATED ART

Present general purpose processing chips are not ideally suited to the task of public-key cryptographic operations. Accordingly, many computing systems include stand alone cryptography units which may be included on-chip along with general-purpose cores. However, cryptography units represent wasted space for those customers who do not need high cryptographic performance. Floating point units are often similarly included on-chip for performing specialized floating point processing. However, the set of customers that desire high cryptographic performance is typically disjoint from those requiring high floating point performance.

Correspondingly, improvements in the integration of cryptographic and floating point units in processing systems would be desirable.

### SUMMARY OF THE INVENTION

Various embodiments are presented of a system comprising a floating point unit and a cryptographic unit having a shared multiplier tree.

A device may include a multiplier tree, a floating point unit (FPU), and a cryptographic unit (CU). The device may also include a general purpose processing unit or processing core that utilizes the FPU and/or the CU. The FPU may be configured to perform floating point operations, and the CU may be configured to perform cryptographic operations. The FPU and the CU may share the multiplier tree.

The multiplier tree may include a feedback path and memory elements included in the feedback path. During the floating point operations of the FPU, the multiplier tree may be configured to perform multiply operations for the FPU. The feedback path and the memory elements may not be used when the FPU is performing floating point operations.

During cryptographic operations, the multiplier tree may be configured to perform multiply operations for the CU. The CU may be configured to use the feedback path and/or the memory elements in the multiplier tree during cryptographic operations. In one embodiment, the feedback path may be configured to provide data from a previous cycle to a current cycle. For example, the memory elements may be configured to save an upper portion (or other portion) of a multiplication result and provide the result on the feedback path as a lower portion (or other portion) additive value for a subsequent multiply-add operation.

In some embodiments, the FPU and the CU may be configured to share the multiplier tree dynamically based on operations submitted for execution by the device. For example, in one embodiment, the FPU and the CU may be configured to share the multiplier tree on a per cycle basis, where the FPU may be configured to use the multiplier tree in a first cycle, and where the CU may be configured to use the multiplier tree in a next second cycle.

Alternatively, or additionally, the FPU and the CU may be configured to share the multiplier tree on a per thread basis, where the FPU may be configured to use the multiplier tree for instructions from a first thread, and where the CU may be configured to use the multiplier tree for instructions from a second thread.

In one embodiment, either the FPU or the CU may be configured to use the multiplier tree exclusively based on a configuration parameter. The configuration parameter may be determined at various times by various entities. For example, the configuration parameter may be determined by an operating system. In one embodiment, the configuration parameter may be determined during a boot up sequence of a computer comprising the device. Use of the multiplier tree by the FPU or the CU may also be assigned at other time times or by other entities, as desired.

Accordingly, a method for performing operations in a processor system may include receiving a floating point instruction and correspondingly performing floating point operations in response to the floating point instruction. Performing floating point operations may include the multiplier tree performing multiply operations. The method may further include receiving a cryptographic instruction and correspondingly performing cryptographic operations in response to the cryptographic instruction.

As indicated above, the feedback path and memory elements may be used during cryptographic operations but may not be used during floating point operations. For example, performing cryptographic operations may include using the feedback path to provide data from a previous cycle to a current cycle. In a more specific example, performing cryptographic operations may include saving an upper portion of a multiplication result in one or more of the memory elements and providing the result on the feedback path as a lower portion additive value for a subsequent multiply-add operation, although other embodiments are envisioned.

The method may further include reserving the multiplier tree for use during either performing floating point operations or performing cryptographic operations. Reserving the multiplier tree may be performed dynamically based on operations submitted for execution to the processor system. Alternatively, or additionally, the method may include reserving the multiplier tree for use during floating point operations in a first one or more cycles and reserving the multiplier tree for use during cryptographic operations in a next second one or more cycles.

In one embodiment, the floating point instruction(s) may be received from a first thread and the cryptographic instruction(s) may be received from a second thread. Accordingly, the method may further include performing floating point operations in response to future instructions from the first thread using the multiplier tree and performing cryptographic operations in response to future instructions from the second thread using the multiplier tree.

Finally, the method may include receiving a first configuration parameter assigning the multiplier tree for use during floating point operations and receiving a second configuration parameter assigning the multiplier tree for use during cryptographic operations.

### BRIEF DESCRIPTION OF THE DRAWINGS

A better understanding of the present invention can be obtained when the following detailed description of the preferred embodiment is considered in conjunction with the following drawings, in which:

FIGS. 1A-1C are block diagrams illustrating exemplary embodiments for sharing a multiplier tree between a floating point unit and a cryptographic unit;

FIGS. 2A-2E are block diagram illustrating operation of various embodiments of the operation of the multiplier tree;

FIGS. 3A-3C are diagrams illustrating various embodiments of the operation of the multiplier tree; and

FIG. 4 is a flowchart illustrating an exemplary embodiment of a method for sharing the multiplier tree between the floating point unit and the cryptographic unit.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Incorporation by Reference:

The following references are hereby incorporated by reference in their entirety as though fully and completely set forth herein:

U.S. Publication No. 2004/0264693, titled “Method and Apparatus for Implementing Processor Instructions for Accelerating Public-Key Cryptography,” filed on Jul. 24, 2003 and published on Dec. 30, 2004.

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

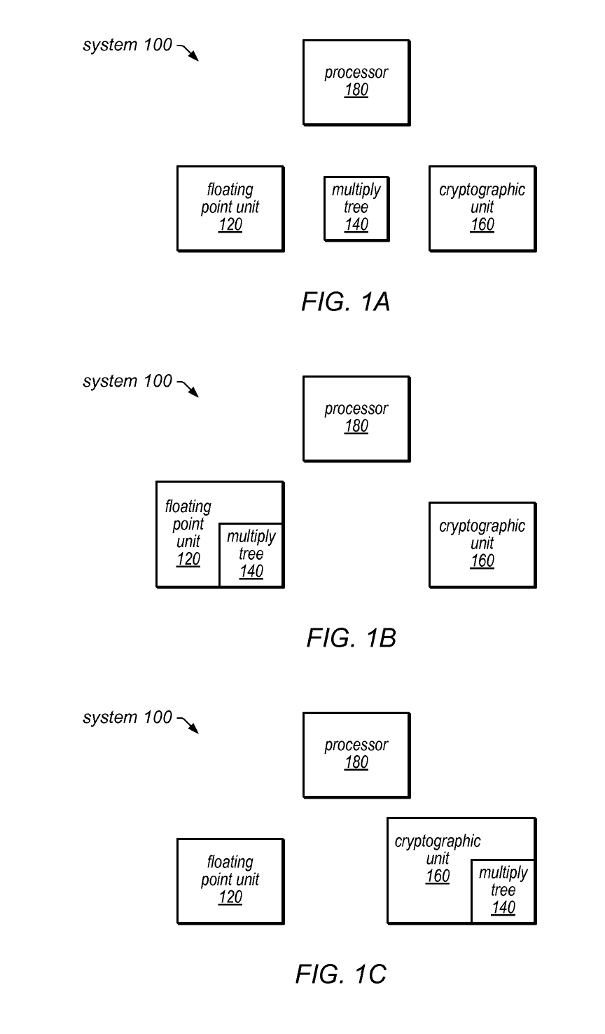

### FIGS. 1A-1C—Block Diagrams of a System

FIGS. 1A-1C are block diagrams illustrating various embodiments of a system 100 comprising a floating point unit and a cryptographic unit which each share a multiplier tree.

As shown in FIG. 1A, the system 100 may include a floating point unit (FPU) 120, a multiplier tree 140, a cryptographic unit (CU) 160, and (optionally) a general processor (or processing core) 180. In the embodiment of FIG. 1A, the multiplier tree 140 may be external to both the FPU 120 and the CU 160. However, as shown in FIG. 1B, the multiplier tree may be included in the FPU 120, or alternatively, as shown in FIG. 1C, the multiplier tree may be included in the CU 160. In another embodiment, respective portions of the multiplier tree 140 may be distributed between the FPU 120 and the CU 160. In some embodiments, the FPU 120, the multiplier tree 140, and the CU 160 may all be within the same pipeline on a single chip (such as the processor 180). Thus, the physical location of the multiplier tree 140 may vary depending on various embodiments, but may be coupled to the FPU 120 and CU 160 in order to allow for efficient use by (or sharing between) the FPU 120 and/or the CU 160. Further descriptions of a method for sharing the multiplier tree 140 (and more specific descriptions regarding the multiplier tree 140) are provided below.

As indicated above, the general processor 180 in the system 100 may use the FPU 120 and/or the CU 160 for more specific operations or instructions (e.g., floating point operations or cryptographic operations, respectively). As also indicated above, the processor 180 may include the FPU 120, the CU 160, and/or the multiplier tree 140, possibly within the same pipeline (e.g., the FMA multiplier pipeline). In some embodiments, the FPU 120 and/or the CU 160 may be coupled to the processor 180 as coprocessors internal or external to the processor 180. Furthermore, in some embodiments, the FPU 120, the multiplier tree 140, and/or the CU 160 may be associated with a single core (or with one or more cores) of a plurality of cores in the system 100. Other FPUs, CUs, and/or multiplier trees may be associated with each core (or with other cores) of the plurality of cores. In other words, in one embodiment, each processing core may have an associated FPU 120, CU 160, and multiplier tree 140 in the system 100.

In one embodiment, the CU 160 and/or the multiply tree 140 (e.g., the memory elements and feedback path of the multiply tree) may be protected from access from or other interaction with the FPU 120, the processor 180 and/or other elements. This may allow for cryptographic information/operations to be performed more securely.

Note that the system 100 may further include other elements that are not shown, as desired. For example, the system 100 may include various memory mediums, registers, busses, caches, processors, cores, peripherals, timing devices, etc. In one embodiment, the system 100 may be a general use computer, such as a personal computer or server, a network device such as a router or switch, or a consumer electronic device (e.g., mobile devices, cell phones, personal digital assistants, portable media players, etc.) which requires processing of instructions, among other possible systems.

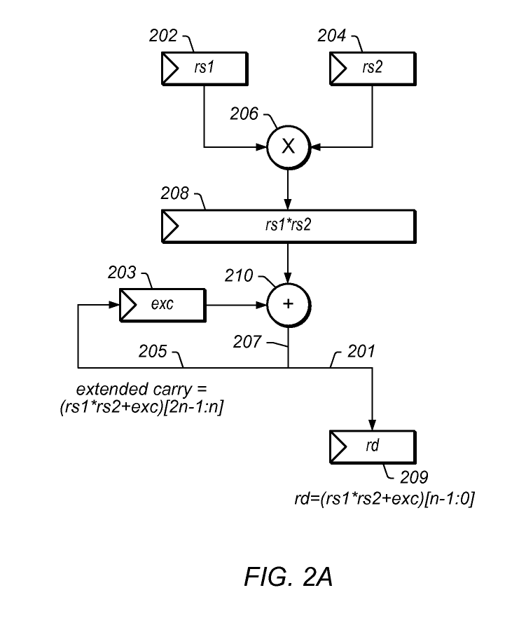

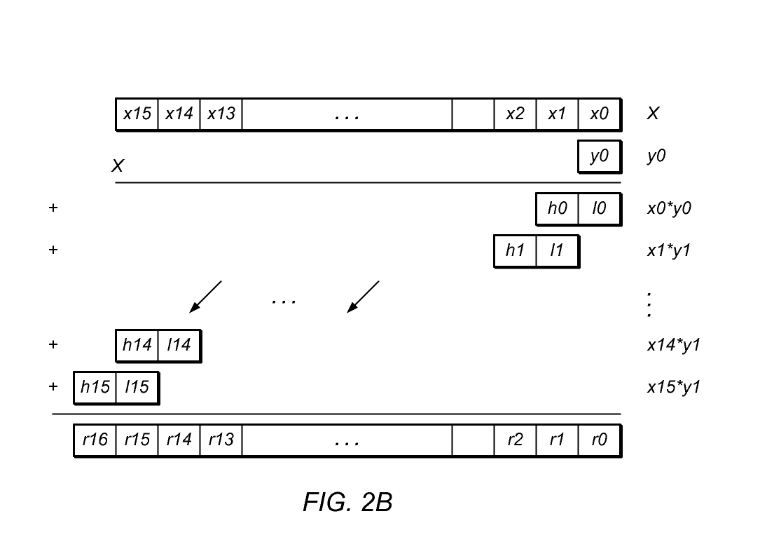

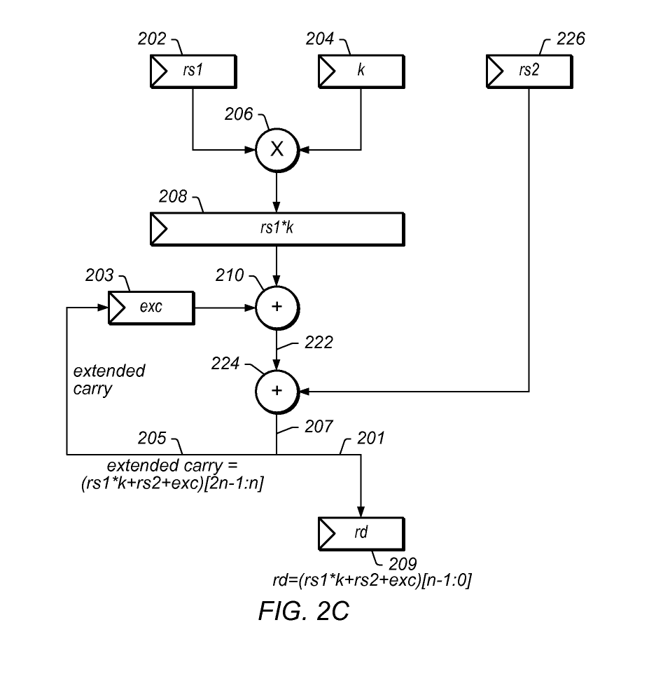

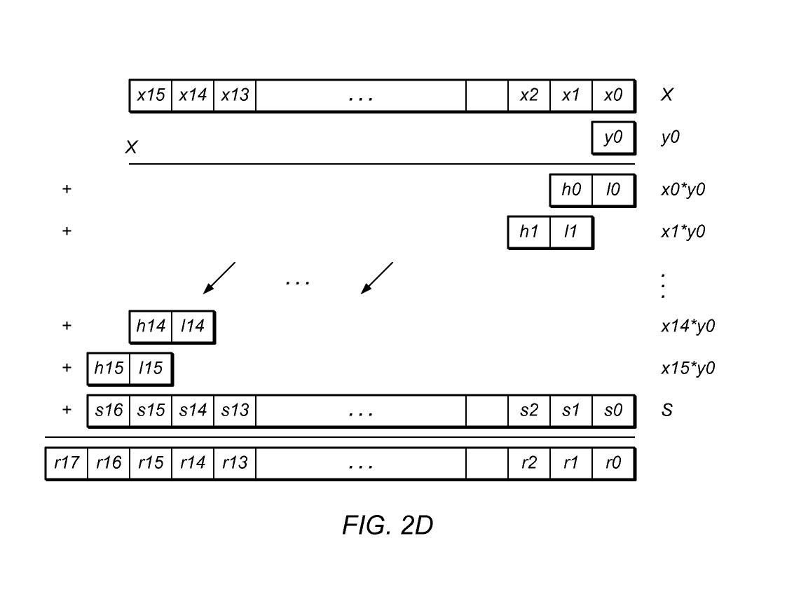

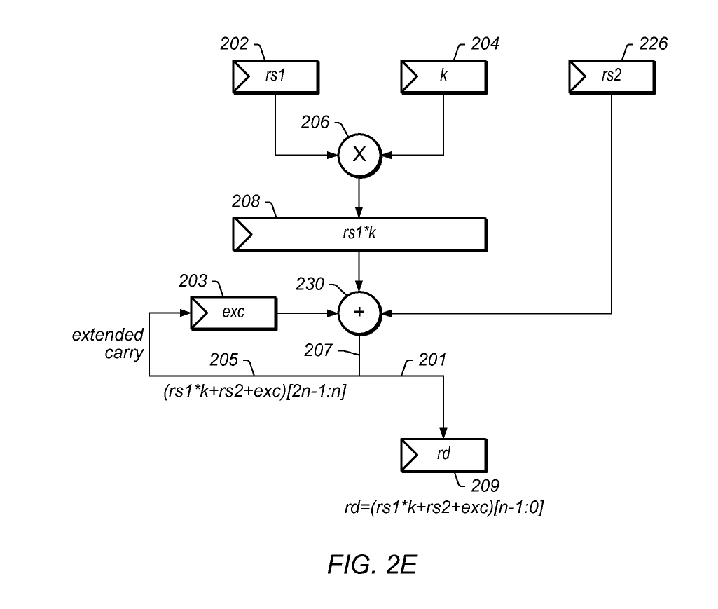

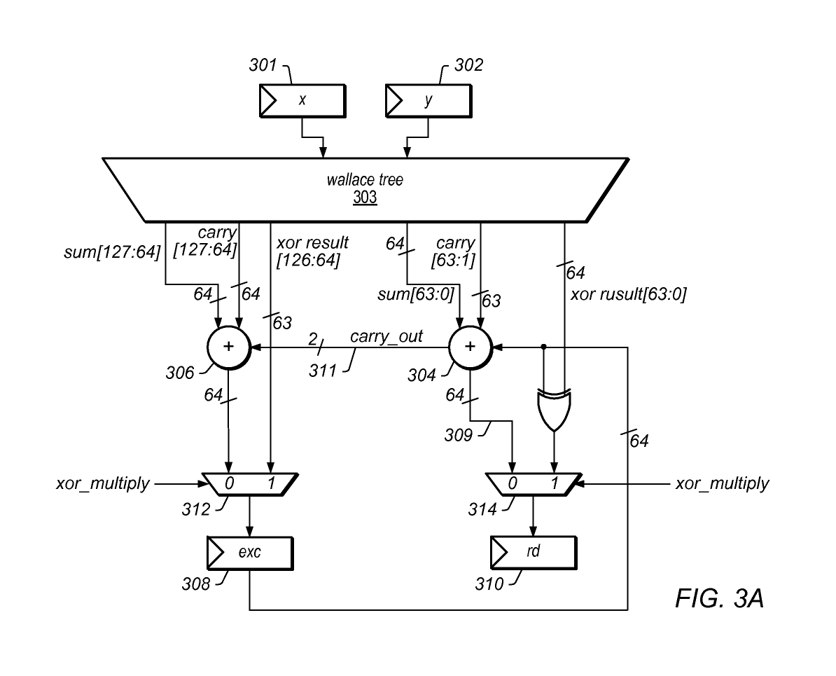

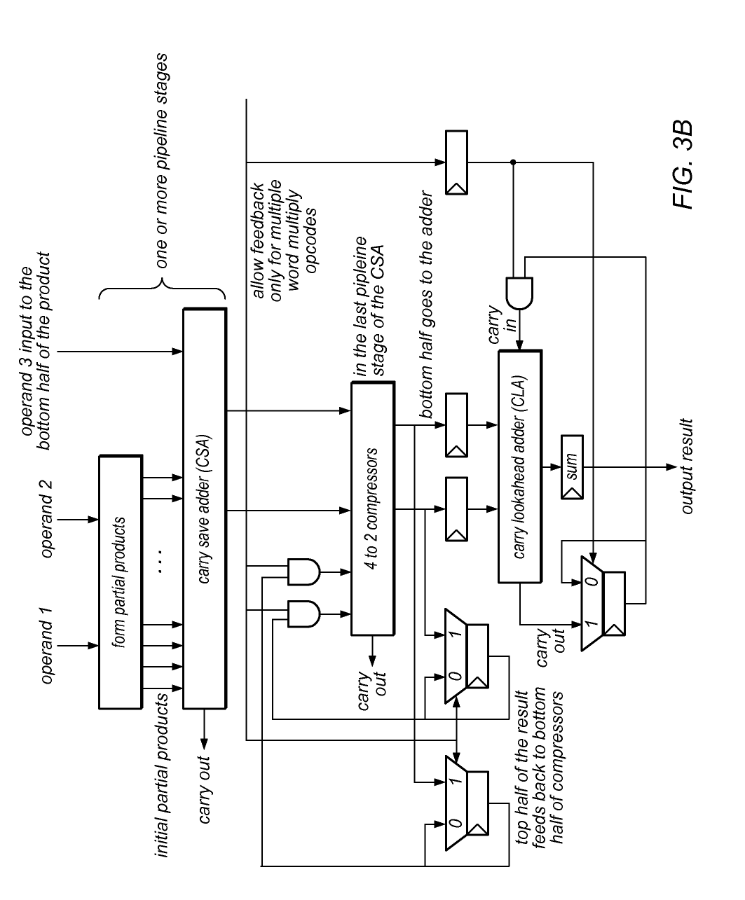

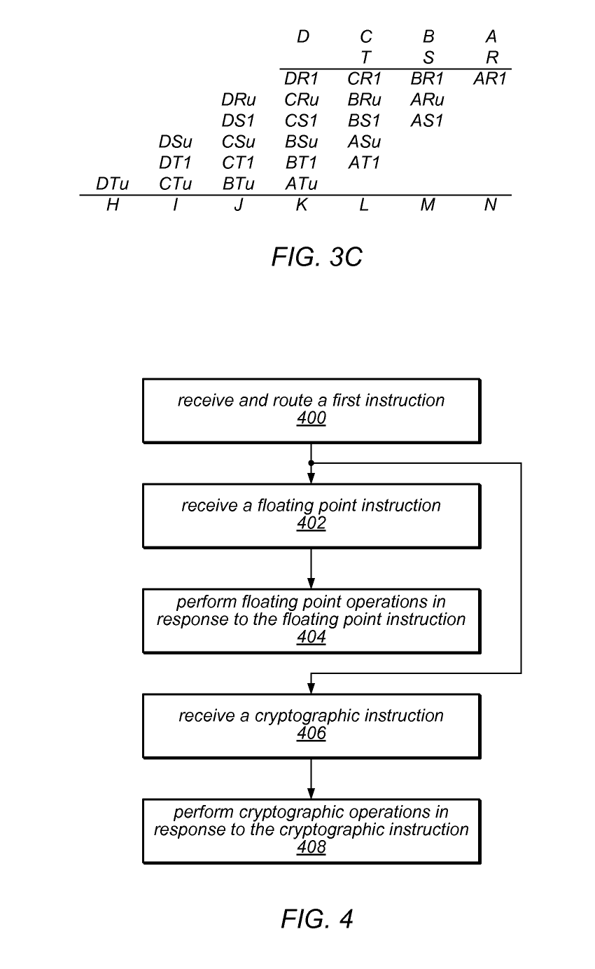

FIGS. 2A-3C—Exemplary Diagrams of the Multiplier Tree

FIGS. 2A-2E are exemplary diagrams of various embodiments of operation of the multiplier tree 140. FIGS. 2A-2E illustrate portions of the multiplier tree 140 and/or operations relevant to the shared use of the multiplier tree 140 as described herein. As noted above, the feedback path in each of FIGS. 2A-2E may be used when the multiplier tree 140 is performing cryptographic operations as described herein. The feedback path in each of FIGS. 2A-2E may not be used when the multiplier tree 140 is performing floating point operations as described herein.

FIG. 2A illustrates one embodiment of execution of a umulxc instruction operable to be carried out by the multiplier tree 140. In some embodiments, an Unsigned MULtiply eXtended-word with Carry, umulxc, may indicate an instruction which multiplies its input registers, rs1*rs2 and adds the previous carry to produce both an integer result and a new carry out. The umulxc instruction is executable by the multiplier tree 140 to perform a multiply wherein the upper bits of the prior result are added to the multiply operation.

FIG. 2B shows an example of a multi-word multiplication y0*X where y0 is a 64-bit integer and X is a 1024-bit integer X=(x15, . . . , x1, x0). The multiplication may be explained assuming the instructions umulxhi and mulx are available. The instruction umulxhi (rs1, rs2, rd) is an unsigned operation that multiplies two 64 bit numbers specified as the source operands rs1 and rs2 and places the high 64 bits of the 128 bit result in the destination register rd. The instruction mulx (rs1, rs2, rd) multiplies two 64 bit numbers specified in the source operands rs1 and rs2 and places the low 64 bits of the 128 bit result in the destination register rd. Assuming such instructions, the computation y0*X can be carried out in the following instruction steps, where h0 represents the high 64 bit result of multiplying x0 and y0 and l0 represents the lower 64 bit result of multiplying x0 and y0:

h0=umulxhi x0, y0;

l0=mulx x0, y0;

h1=umulxhi x1, y0;

l1=mulx x1, y0;

. . .

h15=umulxhi x15, y0;

l15=mulx x15, y0;

r0=l0;

r1=addcc h0, l1; //set carryout bit

r2=addxccc h1, l2; //use, then set the carryout bit.

. . .

r15=addxccc h14, l15; //use, then set carryout bit

r16=addxc h15,0; //use carryout bit

Note that the upper 64-bits, for example, h0, of a 128-bit partial product x0*y0 may be manually propagated into the next partial product x1*y0 using an addcc instruction. That process is typically slow because the output is delayed by the multiplier latency, which may be, e.g., an 8-cycle latency in the case of an exemplary processor. The present invention provides a more efficient technique for efficiently handling the propagation of the upper 64-bits of a 128-bit product into a next operation.

In one embodiment, an unsigned multiplication using an extended carry register (the instruction umulxc, e.g., illustrated in FIG. 2A) may perform a multiply-and-accumulate computation and returns the lower 64-bits of (rs1*rs2+previous extended carry) and saves the upper 64 bits of the result in an extended carry register to be used by the next multiply operation. The lower 64 bits of the multiply-and-accumulate result may be referred to herein as the product and the upper 64 bits are referred to herein as the extended carry. While traditionally an add carryout is only 1 bit and is contained in location cc, the instruction umulxc may define a 64-bit extended carry register (exc) that contains the extended carry bits. The extended carry register may enable the automatic propagation of the carryout bits in a multiply-chaining operation such that a multi-word multiplication can be executed in consecutive instructions.

As shown in FIG. 2A, source operands rs1 and rs2 are obtained from respective registers 202 and 204. The source operands rs1 and rs2 are provided to a multiplier 206 which multiplies the source operands rs1 and rs2 and produces an output. The output of the multiplier 206 is provided to a register 208. An output of the register 208 is provided to a sum node 210. The sum node 210 also receives an input from an extended carry register (exc) 203. The output of the sum node 207 comprises a first portion 205 and a second portion 201.

As shown, result register rd (209) may receive the lower n bits [n-1:0] 201, i.e., the second portion 201 of result 207. The lower n bits may comprise: rs1*rs2+extended carry previously saved in the extended carry register (exc) 203. The upper n bits [2n−1:n] 205 of 207 (rs1*rs2+previous exc) may be stored in the extended carry register (exc) 203 for use in subsequent computations. The exc value, saved from the most significant n bits of the result of one operation, may be added into the least significant n bits of the next operation. Note that in the implementation illustrated in FIG. 2A, the exc register 203 may be a register that is logically local to the multiplier, and may be implemented as a special register so that, even though not a general purpose register such as those specified by rs1, rs2 and rd, the exc register can be accessed in association with, e.g., saving and restoring the exc register in association with context switches. The exc register may be used to propagate an n bit extended carry per multiplication. The source operands rs1, rs2, the destination register rd, and the extended carry register are assumed to be n bits. In an exemplary embodiment, n=64.

According to another embodiment, the multiply tree may implement a umulxck instruction, which may effectively combine both multiply and accumulate operations. In some embodiments, the instruction umulxck is an instruction which multiplies its first input register, rs1, times k and adds both the second input register, rs2, as well as the previous carry to produce both an integer result and a new carry out. That is, umulxck computes (rs1*k)+rs2+previous exc to produce both rd and a new exc. In addition to computing a row y0*X, the umulxck instruction also allows for accumulating an additional row S=(s15, . . . , s0) implicitly without requiring additional add (e.g., addxccc) operations. The umulxck instruction is illustrated in FIG. 2C.

FIG. 2C is similar to FIG. 2A, except that an additional connection 222 and add node 224 are inserted between sum node 210 and result 207, thereby allowing for the additional add of rs2 226, as indicated above.

As shown in FIG. 2D, in one implementation, a multiplication algorithm may use a sequence of umulxc instructions to compute a row (e.g., y0*X) and a sequence of add instructions, e.g., addcc, addxccc, to accumulate two rows. Note that the first instruction umulxc 0,0; clears the extended-carry register. Alternatively, an instruction can be defined that produces, but does not consume an extended carry, and can be utilized to compute r0, to eliminate the need for an explicit instruction clearing the extended carry register.

In one embodiment, umulxck, effectively combines both multiply and accumulate operations. In addition to computing a row y0*X, the umulxck instruction also allows for accumulating an additional row S=(s15, . . . , s0) implicitly without requiring additional add (e.g., addxccc) operations. The umulxck instruction is illustrated in FIG. 2C.

As shown in FIG. 2C, the result register rd (209) may receive the lower n bits 201 of register 207. More specifically, it may receive: rs1*k+previous extended carry saved in the extended carry register (exc) 403+rs2. The extended carry register 203 may receive the upper n bits 205 for use in subsequent computations. As with the umulxc instruction, the exc value, although saved from the most significant n bits of the result of one operation, may be added into the least significant n bits of the next operation. The register rs2 (226) may be used to provide the words of the accumulated partial products. Note that in the implementation illustrated in FIG. 2C, the extended carry register may be logically local to the multiplier and may be used to propagate an n-bit extended carry per multiplication. The exc register illustrated in FIG. 2C may be implemented as a special register so that, even though not a general purpose register such as those specified by rs1, rs2 and rd, the exc register can be accessed in association with, e.g., saving and restoring the exc register in association with context switches. The source operands rs1, rs2, the destination register rd, the extended carry register and the k register are assumed to be n bits, e.g., where n=64.

In the embodiment illustrated in FIG. 2C, the umulxck instruction may use a logically local register k rather than a general-purpose register for two reasons. First, some instruction formats, e.g., the SPARC™ instruction format, may allow for specifying only two source operands. Secondly, one operand may remain constant throughout the computation of an entire partial product and, therefore, can be kept in a local register that is initialized only once for every partial product. The k register illustrated in FIG. 2C may be implemented as a special register so that, even though not a general purpose register such as those specified by rs1, rs2 and rd, the k register can be accessed in association with, e.g., saving and restoring the register in association with context switches. On the other hand, if three input operations are supported, then the k register may also be a general purpose register.

Finally, FIG. 2E illustrates an alternative embodiment of an implementation of the umulxck instruction having a single summing node 230.

FIGS. 3A and 3B illustrate various embodiments of portions of the multiplier tree 140.

FIG. 3A shows a multiply-and-accumulate circuit that may implement a portion of the multiplier tree. The illustrated circuit may multiply the contents of two 64-bit registers X (301) and Y (302) (e.g., using the shown Wallace tree 303), add the contents of a 64-bit extended carry register and output a 128-bit result. The upper 64 bits of the result may be output into 64-bit extended carry (exc) register 308 and the lower 64 bits are output into result register 310. The addition of the 64-bit extended carry (exc) register 308 may be performed in adder circuit 304. Adder circuit 304 may add intermediate results sum[63 . . . 0], carry[63 . . . 1] and exc[63:0] and output a 64-bit addition result 309 and two carry bits 311 that may be input into adder circuit 306. Multiplexers 312 and 314 select between the unsigned integer multiply-accumulate operation (exc, r)=x*y+exc (when multiplexer select xor_multiply=0) and the XOR multiply-accumulate operation (when multiplexer select xor_multiply=1) (exc, r)=(x {̂/*} y){̂/+}exc, where “{̂/*}” indicates XOR multiplication and “{̂/+}” indicates XOR addition. The adder circuit 304 may include a half adder, full adder and adder circuit. Note that the adder circuit may calculate {0, sum out [63], . . . , sum out [0]}+{carry out [64] . . . carry out [1], 0}. Common implementations of the adder circuit may include a ripple-carry-adder, a carry look-ahead adder or a carry-select-adder.

FIGS. 3B and 3C illustrate another circuit that may implement a portion of the multiplier tree 140. The following description is provided to further describe embodiments of the multiplier tree in reference to FIG. 3B. However, the following sections are not intended to limit any of the descriptions herein and are provided as an exemplary embodiment of the multiplier tree.

Multiple word multiplications are needed in public-key encryption systems such as the Rivest-Shamir-Adleman (RSA) public-key algorithm and the Diffie-Hellman (DH) key exchange schemes. These schemes require modular exponentiation with operands of at least 512 bits. Modular exponentiation is computed using a series of modular multiplications and squarings. A newly standardized public-key system, Elliptic Curve Cryptography (ECC), also uses large integer arithmetic, even though it requires smaller key sizes. The Elliptic Curve public-key cryptographic systems operate in both integer and binary polynomial fields. A typical RSA operation requires a 1024 bit modular exponentiation (or two 512 bit modular exponentiations using the Chinese Remainder Theorem). RSA key sizes are expected to grow to 2048 bits in the near future. A 1024 bit modular exponentiation includes a sequence of large integer modular multiplications, each in turn is further broken up into many word size multiplications. In total, a 1024 bit modular exponentiation requires over 1.6 million 64 bit multiplications. Thus public-key algorithms are compute intensive with relatively few data movements.

In order to better support cryptographic applications, it is desirable to enhance the capability of general purpose processors to accelerate public-key computations. The multiplication of any multiple word values will benefit from this method, not just cryptographic applications.

The storage of integer values with more than 64 bits requires multiple computer words. The multiplication of such words is tedious. The SPARC opcodes provide some support. There are two 64 bit multiplication instructions, mulx and umulxhi. The mulx instruction multiplies two 64 bit values and returns the lower order 64 bits of the product. The umulxhi instruction multiplies two 64 bit values and returns the upper order 64 bits of the product. Thus, to multiply n 64 bit words by m 64 bit words requires n*m executions of the mulx instruction and also n*m executions of the umulxhi instruction. This produces 2*n*m 64 bit words that need to be added together. For example, consider n=4 and m=3. Represent the 4 word value as the 64 bit words D, C, B, and A where D is the most significant 64 bits and A is the least 64 bits of the 256 bit value. Represent the 3 word value as the 64 bit words T, S, and R where T is the most significant 64 bits and R is the least 64 bits of the 192 bit value. Represent the result of the mulx instruction of, say, A and R by ARl (l for lower) and the result of the umulxhi instruction of A and R by ARu (u for upper). The initial partial products for this multiplications are shown in FIG. 3C

The lower order 64 bits, N, of the result is ARl. The next 64 bits, M, is the sum of BRl, ARu, and ASl. Then the next 64 bits, L, is the sum of CRl, BRu, BSl, ASu, and ATl plus the carry out from the sum of BRl, ARu, and ASl. As an aid in adding the carries from one column to the next, the addxccc instruction includes the xcc.c bit in an addition and sets the carry out bit xcc.c.

This section presents a hardware organization for a multiplier that enables multiple word multiplies to be carried out with greater efficiency. The number of multiplies is cut nearly in half to n*(m+1)+1. No addition operations may be needed. The number of clock cycles to perform the multiple word multiply is n*(m+1) plus the pipeline latency of the multiplier. This is a speed-up by a factor of two to four. Furthermore, the amount of memory space is reduced to only the input operands and the result location, as all intermediate partial products that need to be stored are contained within the result storage area.

A typical organization of multiply hardware may include the following pipeline stages:

1. Form the partial products and start the carry save adder (CSA), reducing the number of partial product terms.

2. Finish the CSA, further reducing the number of partial product terms to two.

3. Carry lookahead add (CLA) the two partial product terms to get the result.

Note that the result contains twice as many bits as each input. Thus, the output is either the lower or upper half of the result, but not both.

The multiple word multiply organization pipeline stages contains the following (see FIG. 3B):

1. Form the partial products and start the CSA, reducing the number of partial product terms. A third input is included as an additional partial product term.

2. Finish the CSA, further reducing the number of partial product terms to two. This stage also includes as input into the lower half two more partial product terms that are the upper half of the resulting two partial product terms from the previous multiple word multiply opcode.

3. Carry lookahead add the lower half of the two partial product terms plus the carry in, which is the carry out from the addition in the previous multiple word multiply opcode. The output is the result of this addition, without the carry out.

The feedbacks to the compressors and adder may only occur during the opcode for multiple word multiplies. At all other times, the values may be held and zeros are fed back. This may allow for other operations and interrupts to take place interspersed within the computation.

For the four word by three word example, the instruction sequence is shown below. Note that the result is placed in locations N, M, L, K, J, I, and H where N contains the least significant 64 bits and H contains the most significant 64 bits.

(any*zero)+zero −>discard

R*A+zero→N

R*B+zero→M

R*C+zero→L

R*D+zero→K

R*zero+zero→J

S*A+M→M

S*B+L→L

S*C+K→K

S*D+J→J

S*zero+zero→I

T*A+L→L

T*B+K→K

T*C+J→J

T*D+I→I

T*zero+zero→H

The above sequence is repeated here with the intermediate values shown:

?*0+input 0+internal unknown−>internal 0, output (discard=unknown)

R*A+input 0+internal 0−>internal ARu, output (N=ARl)

R*B+input 0+internal ARu−>internal BRu, output (M=BRl+ARu)

R*C+input 0+internal BRu→internal CRu, output (L=CRl+BRu)

R*D+input 0+internal CRu→internal DRu, output (K=DRl+CRu)

R*0+input 0+internal DRu→internal 0, output (J=DRu)

S*A+input (M=BRl+ARu)+internal 0→internal ASu, output (M=BRl+ARu+ASl)

S*B+input (L=CRl+BRu)+internal ASu→internal BSu, output (L=CRl+BRu+BSl+ASu)

S*C+input (K=DRl+CRu)+internal BSu→internal CSu, output (K=DRl+CRu+CSl+BSu)

S*D+input (J=DRu)+internal CSu→internal DSu, output (J=DRu+DSl+CSu)

S*0+input 0+internal DSu→internal 0, output (I=DSu)

T*A+input (L=CRl+BRu+BSl+ASu)+internal 0→internal ATu, output (L=CRl+BRu+BSl+ASu+ATl)

T*B+input (K=DRl+CRu+CSl+BSu)+internal ATu→internal BTu, output (K=DRl+CRu+CSl+BSu+BTl+ATu)

T*C+input (J=DRu+DSl+CSu)+internal BTu→internal CTu, output (J=DRu+DSl+CSu+CTl+BTu)

T*D+input (I=DSu)+internal CTu→internal DTu, output (I=DSu+DTl+CTu)

T*0+0→internal 0, output (H=DTu)

Consider a k by k multiply. The largest value each input can be is 2̂k−1. If we add to this two additional k bit values, then the largest value that can result is:

(2̂k−1)̂2+2(2̂k−1)=2̂(2k)−2(2̂k)+1+2(2̂k)−2=2̂(2k)−1

and that is also the largest value that can be in a 2k bit result. So, to the product of two k bit values, two more k bit values may be added and the result still fits in the 2k bit result. Thus, the carry out of the CSA and the carry out of the 4 to 2 compressors are both zero. If one of the k bit values that is added to the product is the most significant half (e.g., the upper) k bits of the previous such operation, then even though this value may be contained in two k bit registers (as shown in FIG. 3B), the value expressed in these two register (that feeds back the value) does not exceed 2̂k−1

When Booth encoding is used to form the partial products for the CSA, the carry out of the CSA and/or the 4 to 2 compressors may not be zero. This is because Booth encoding uses negative multipliers. Booth encoding considers bits of the multiplier in pairs instead of one at a time. Zero, one, and two times the multiplicand is obtained with a mux, but three times the multiplicand cannot be done quickly. So instead, we use 3=4−1 with the value of 4 saved for the next pair and −1 used with this pair. Negative numbers (in twos complement form) have an infinite number of one bits going of to the left (the most significant bit positions). If everything is added up, a carry will propagate through this infinite row of ones, setting them all to zero. However, in the CSA and the 4 to 2 compressors, the summation is not yet complete, so the propagation may or may not have reached the carry out position. So, when the two bit values are fed back, if both carry outs are zero, then the carry that removes the leading ones has not yet reached the carry out position and so k ones may need to be concatenated to the left of one of the terms being feed back. However, if either carry out is one, then the carry that removed the leading ones has reached the carry out position and so k zeros may need to be concatenated to the left of one of the terms being feed back.

When there is a change of context, it may be necessary to save the current internal value (for the context that is being suspended) and restore the saved internal value (for the context that is being resumed). The current internal value may be obtained by executing the multiple word multiply opcode with zero times zero, plus zero. Then the current internal value is the output of the operation and that value then can be saved just as the register values are saved when there is a change of context. To restore the saved internal value that has been previously saved, the multiple word multiply operation may be used. Let V be the saved value that is to be restored to the internal state. The multiple word multiply opcode may be executed with input values V(2̂k−1)+V (note that 2̂k−1 is the value with all the bits turned on). This places the value of V into the internal state. Notice that as the value of V becomes the new internal value, what was the current internal value is output. Thus, the saved value V may be saved and the current internal value may be obtained at the same time with just one execution of the multiple word multiply operation. If the internal state is only accessible by software (e.g., supervisor or hypervisor) that may not be subject to context switching, then saving and restoring the internal state may not be necessary.

If the option of an integer multiply-add (without internal feedback) is desired, then it can easily be implemented as the same as the multiple word multiply operation except that the internal feedback is turned off, as it is on all other instructions. Note that these instructions may not use the internal state and can be freely intermixed with those that do.

Thus, FIGS. 2A-3C illustrate various embodiments of diagrams and operations of the multiplier tree 140. However, it should be noted that the provided Figures and descriptions are exemplary only and further variations are envisioned. Further details regarding the multiplier tree can be found in U.S. Publication No. 2004/0264693 which was incorporated by reference in its entirety above.

### FIG. 4—Flowchart

FIG. 4 illustrates a method for sharing a multiplier tree between a cryptographic unit and a floating point unit. The method shown in FIG. 4 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 400, a first instruction may be received by a processing system and may be appropriately routed. In some embodiments, the first instruction may be received from an operating system or hypervisor, thread, or other sources.

In some embodiments, the first instruction may be identified (e.g., by an opcode or other label) as a floating point or cryptographic instruction. Accordingly, the first instruction may be routed for execution using floating point operations (e.g., by an FPU, such as the FPU 120 described above) in 402 or cryptographic operations (e.g., by a CU, such as the CU 160 described above) in 406 accordingly. In one embodiment, a multiply tree (such as the multiply tree 140 described above) may be reserved for the floating point operations or cryptographic operations respectively. Thus, in one example, the nature of the first instruction may be determined, and, if the first instruction is a floating point instruction, the multiplier tree may be reserved for the FPU, and the first instruction may be executed using the FPU and the multiplier tree. Similarly, the multiplier tree may be reserved for the CU if the first instruction is a cryptographic instruction and requires multiplication. Thus, instructions may be routed on an instruction or cycle by cycle basis.

In another embodiment, the first instruction may be routed on a thread by thread basis. For example, if the first instruction is received from a first thread that is associated (or has been previously associated) with floating point operations, the first instruction may be routed and/or labeled (e.g., by an opcode or other labeling method) for floating point operations in 402 (e.g., to an FPU, such as the FPU 120 described above). Alternatively, if the first instruction is received from a second thread that is associated (or has been previously associated) with cryptographic operations, the first instruction may be routed and/or labeled for cryptographic operations in 406 (e.g., to a CU, such as the CU 160 described above). Thus, in one embodiment, the instructions may be routed to various processing units on a thread basis, where instructions from a first thread are routed to the FPU and instructions from a second thread are routed to the CU. The multiplier tree may be reserved fro the FPU or the CU accordingly.

Routing of the first instruction may be determined according to one or more parameters, as desired. For example, in one embodiment, a parameter may be set which determines whether the multiply tree is reserved for the FPU or the CU. Correspondingly, the first instruction may be routed according to the setting of the parameter. For example, if the parameter indicates that the multiplier tree is reserved for use by the FPU, no instructions (or possibly no instructions requiring the multiply tree) may be assigned to the CU. Similarly, if the parameter indicates that the multiplier tree is reserved for use by the CU, no instructions (or possibly no instructions requiring the multiply tree) may be assigned to the FPU. In such embodiments, instructions that would have been destined to the FPU or CU may be instead executed by another processor, such as a general processor.

In some embodiments, the parameter may be assigned or determined at various times. For example, the parameter may be assigned during initial set up of a processing system including the FPU, CU, and multiplier tree (e.g., a computer or other processing device), during boot up of the system, at various time intervals during operation of the system, by the operating system of the system (e.g., on a thread by thread basis, cycle basis, instruction basis, or otherwise), and/or during other times.

In one embodiment, a first parameter may be received assigning the multiplier tree for use during floating point operations (e.g., by the FPU), and subsequently a second parameter may be received assigning the multiplier tree for use during cryptographic operations (e.g., by the CU). Thus, in one embodiment, the first parameter may indicate that the FPU use the multiply tree for a first time period, and after the second parameter is received, the CU may use the multiply tree for a second time period. The first parameter may be received according to any of the times described above, and similarly, the second parameter may be received according to any subsequent time described above. Note that receiving the first parameter and receiving the second parameter may refer to receiving the same parameter, but with different values, or simply overwriting the value of an existing parameter stored in memory, among other possibilities. Thus, sharing or reserving of the multiplier tree (and correspondingly, routing of instructions) may be determined according to the parameter.

In 402, a floating point instruction may be received. In some embodiments, the floating point instruction may be received by the FPU. Additionally, the floating point instruction may be transmitted by a processor or general processing core (e.g., of a computer). In one embodiment, the floating point instruction may be provided from an operating system or hypervisor of a computer, an execution thread, or others, e.g., according to the reception and routing described in 400.

In 404, floating point operations may be performed in response to the floating point instruction. The floating point operations may be performed by the FPU. The floating point operations (or at least a portion of them) may be performed using a multiply tree (e.g., the multiply tree 140 described above). In other words, the multiply tree may perform multiply operations for the FPU. As noted above, the multiply tree may include a feedback path and memory elements (e.g., for storing previous results, as indicated above); however, during floating point operations involving the multiplier tree, the feedback path and the memory elements may not be used. However, it should be noted that there may be instructions that are executed by the FPU but do not necessarily use the multiply tree.

In 406, a cryptographic instruction may be received. The cryptographic instruction may be received by the CU. Additionally, similar to above, the cryptographic instruction may be transmitted by a processor or processing core, an operating system or hypervisor, etc., e.g., according to the reception and routing described in 400.

In 408, cryptographic operations may be performed in response to the cryptographic instruction. The cryptographic operations may be performed by the CU. At least a portion of the cryptographic operations may be performed using the multiplier tree.

During cryptographic operations involving the multiplier tree, the feedback path and the memory elements may be used. More specifically, performing the cryptographic operations may include using the feedback path to provide data from a previous cycle to a current cycle, e.g., using the memory elements. For example, the memory elements may save a previous result of an immediately preceding operation or cycle (which may not use a holding flop memory element), or may save a previous result of a cycle before the immediately preceding operation or cycle (e.g., using a holding flop memory element). The memory elements may be any of a variety of memory elements, such as, for example, flip flops (e.g., one bit flip flops, holding flip flops, etc.), registers, etc.

In one embodiment, the upper portion of a multiplication result may be stored in one or more of the memory elements and may provide the result on the feedback path as an additive value for a subsequent multiply-add operation. However, it should be noted that there may be instructions that are executed by the FPU but do not necessarily use the multiply tree.

Cryptographic operations, the feedback path, the memory elements, and/or the entirety of the CU may be protected from other elements of the processing system, e.g., the general processor, the FPU, and/or others. For example, the values stored in the memory elements may not be accessible by other elements in the processing system. In some embodiments, this may allow for higher security in the cryptographic operations.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A device, comprising:
a multiplier tree;
a floating point unit configured to perform floating point operations, wherein during the floating point operations the multiplier tree is configured to perform multiply operations for the floating point unit; and
a cryptographic unit configured to perform cryptographic operations, wherein during the cryptographic operations the multiplier tree is configured to perform multiply operations for the cryptographic unit.

2. The device of claim 1, wherein the multiplier tree comprises:
a feedback path; and
memory elements comprised in the feedback path;
wherein the feedback path and the memory elements are not used when the floating point unit is performing floating point operations; and
wherein the cryptographic unit is configured to use the feedback path and/or the memory elements in the multiplier tree during cryptographic operations.

3. The device of claim 1, wherein during cryptographic operations the feedback path is configured to provide data from a previous cycle to a current cycle.

4. The device of claim 1, wherein during cryptographic operations the memory elements are configured to save an upper portion of a multiplication result and provide the result on the feedback path as an additive value for a subsequent multiply-add operation.

5. The device of claim 1, wherein the floating point unit and the cryptographic unit are configured to share the multiplier tree dynamically based on operations submitted for execution by the device.

6. The device of claim 1, wherein the floating point unit and the cryptographic unit are configured to share the multiplier tree on a per cycle basis, wherein the floating point unit is configured to use the multiplier tree in a first cycle, and wherein the cryptographic unit is configured to use the multiplier tree in a next second cycle.

7. The device of claim 1, wherein the floating point unit and the cryptographic unit are configured to share the multiplier tree on a per thread basis, wherein the floating point unit is configured to use the multiplier tree for a first thread, and wherein the cryptographic unit is configured to use the multiplier tree for a second thread.

8. The device of claim 1, wherein either the floating point unit or the cryptographic unit is configured to use the multiplier tree exclusively based on a configuration parameter.

9. The device of claim 8, wherein the configuration parameter is determined by an operating system.

10. The device of claim 8, wherein the configuration parameter is determined during a boot up sequence of a computer comprising the device.

11. A method for performing operations in a processor system, the method comprising:
receiving a floating point instruction;
performing floating point operations in response to the floating point instruction, wherein said performing floating point operations comprises a multiplier tree performing multiply operations, wherein the multiplier tree comprises a feedback path and memory elements comprised in the feedback path, wherein the feedback path and the memory elements are not used during said performing floating point operations;
receiving a cryptographic instruction;
performing cryptographic operations in response to the cryptographic instruction, wherein said performing cryptographic operations comprises the multiplier tree performing multiply operations, wherein the feedback path and/or the memory elements in the multiplier tree are used during the cryptographic operations.

12. The method of claim 11, wherein said performing cryptographic operations comprises using the feedback path to provide data from a previous cycle to a current cycle.

13. The method of claim 11, wherein said performing cryptographic operations comprises saving an upper portion of a multiplication result in one or more of the memory elements and providing the result on the feedback path as an additive value for a subsequent multiply-add operation.

14. The method of claim 11, further comprising:
reserving the multiplier tree for use during either said performing floating point operations or said performing cryptographic operations.

15. The method of claim 14,
wherein said reserving is performed dynamically based on operations submitted to for execution to the processor system.

16. The method of claim 14,
wherein said reserving comprises reserving the multiplier tree for use during said performing floating point operations in a first one or more cycles and reserving the multiplier tree for use during said cryptographic operations in a next second one or more cycles.

17. The method of claim 11,
wherein the floating point instruction is received from a first thread;
wherein the cryptographic instruction is received from a second thread;
wherein the method further comprises:
performing floating point operations in response to future instructions from the first thread using the multiplier tree; and
performing cryptographic operations in response to future instructions from the second thread using the multiplier tree.

18. The method of claim 11, wherein the method further comprises:
receiving a first configuration parameter assigning the multiplier tree for use during floating point operations; and
receiving a second configuration parameter assigning the multiplier tree for use during cryptographic operations.

19. A system, comprising:
a processor core configured to perform processing operations;
a floating point unit configured to perform floating point operations;
a cryptographic unit configured to perform cryptographic operations;
a multiplier tree for performing multiply operations for the floating point unit and the cryptographic unit, wherein the multiplier tree comprises:
a feedback path; and
memory elements comprised in the feedback path;
wherein the feedback path and the memory elements are not used when the multiplier tree is performing multiply operations for the floating point unit;
wherein the multiplier tree is configured to use the feedback path and/or the memory elements when the multiplier tree is performing multiply operations for the cryptographic unit.

20. The system of claim 19,
wherein during cryptographic operations the memory elements are configured to save an upper portion of a multiplication result and provide this result on the feedback path as an additive value for a subsequent multiply-add operation.
